(19) United States
(12) Patent Application Publication
(10) Pub. No.: US 2026/0235861 A1
(43) Pub. Date: Aug. 13, 2026

(54) CAMERA ADAPTER

(71) Applicant: Carl Zeiss Microscopy GmbH, Jena (DE)

(72) Inventors: Thomas NOBIS, Leipzig (DE); Peter SCHNUELL, Gleichen (DE)

(21) Appl. No.: 19/462,270

(22) Filed: Jan. 28, 2026

(30) Foreign Application Priority Data
Feb. 12, 2025 (DE) 10 2025 105 159.3

(51) Int. Cl. G02B 21/36; G02B 9/12; G02B 13/00; G03B 17/56

(52) U.S. Cl. CPC G02B 21/361; G02B 9/12; G02B 13/0035; G02B 13/006; G02B 21/362; G03B 17/561; G03B 17/565

(57) ABSTRACT

A camera adapter for arrangement in a convergent beam path of a microscope comprises an object-side connector, an image-side connector, and a plurality of lenses. The lenses are arranged in at least two groups. The first group of the lenses has a positive refractive power. The second group of the lenses has a negative refractive power.

### CROSS-REFERENCE TO RELATED APPLICATION

This application claims benefit under 35 U.S.C. § 119 to German Application No. 10 2025 105 159.3, filed Feb. 12, 2025. The entire disclosure of this application is incorporated by reference herein.

### FIELD

The disclosure relates to a camera adapter. The disclosure also relates to a camera system having such an adapter. The disclosure further relates to a microscope having such a camera adapter.

### BACKGROUND

In general, an adapter is used in order to connect a camera to a microscope. Beam path vignetting may occur in this context on account of a limited diameter, for example as regards the camera-side connector of such an adapter.

A camera adapter is known from DE 10 2009 010 448 B4, for example. This camera adapter is designed for arrangement in a parallel beam path.

### SUMMARY

The present disclosure seeks to provide an improved camera adapter for a microscope.

According to one aspect, the adapter is designed for arrangement in a convergent beam path of a microscope. For example, it may be arranged in the beam path downstream of a tube lens.

The camera adapter according to the disclosure may serve for example for imaging an intermediate image, for example a corrected intermediate image, onto a camera sensor.

For example, this may be a camera adapter for wide-field microscopy. The adapter according to the disclosure serves for example for imaging a field of view with a diameter in the range from 20 mm to 25 mm, for example a diameter of at least 23 mm. The diameter of the field of view corresponds to the diameter of the object field multiplied by the magnification of the objective lens.

The image-side connector is also referred to as an interface. For example, it may comprise an interface, for example a mechanical interface. The interface may also comprise an electrical interface. The interface may for example comprise one or more means for transmitting data and/or energy.

The image-side connector may be standardized for example.

The image-side connector serves for example for connecting a camera.

For example, the image-side connector may comprise a thread or a bayonet connector.

This may facilitate connecting a camera.

According to one aspect, the adapter may have a paraxial magnification in the range from 0.5 to 0.8, for example in the range from 0.6 to 0.7, for example in the range from 0.63 to 0.65.

It is believed that camera adapters with a magnification in the range from 0.5 to 0.8, for example with a magnification in the range from 0.62 to 0.65, and an image-side connector with a clear diameter of no more than 21 mm, which are capable of transmitting the full étendue of a field of view with a diameter of more than 20 mm, for example at least 23 mm, for example at least 25 mm, onto a camera sensor, for example with a camera sensor diagonal of more than 11 mm, for example 16 mm, do not exist at the present time.

It was found that the adapter of the present disclosure allows low-loss imaging, for example lossless imaging, of the image field onto typical camera sensors. For example, at least 90% of the total étendue of the microscope stand, for example the total étendue, can be imaged on the sensor of the camera provided.

The product of transmitted field of view and the image-side numerical aperture is referred to as the étendue.

A camera uses a relatively large number of pixels in order to be able to acquire the largest possible proportion of the information in the image field. The number of pixels is dependent on the étendue.

However, the pixel dimension is also relevant for the dynamic range of a camera image. Larger pixels can be desirable in the case of unfavourable lighting conditions or in the case of small amounts of light. For low-light applications in wide-field microscopy, for example in fluorescence microscopy, it is therefore desirable to image the entire étendue of the stand or of the objective lens onto a camera with pixels that are as large as possible, i.e. onto a camera having a sensor that is as large as possible. For example, the camera sensor may have a format of ⅔″, i.e. a diagonal of 11 mm, or of 1″, i.e. a diagonal of 16 mm. In this case, the specifications in inches correspond to the customary specifications for CCD and CMOS sensors. A sensor whose light-sensitive area corresponds to a 1 inch tube (1″ tube) is referred to here as a 1 inch sensor. Smaller chips are generally not capable of receiving the entire étendue, certainly not in the case of an adapter with a paraxial magnification in the specified range.

For example, imaging a field of view with a diameter of 25 mm onto a sensor with a diagonal of 16 mm uses an adapter with a magnification of V=0.64.

According to an aspect, the image-side connector is in the form of a C-mount connector. The connector may have a 1″ male thread for example.

The connector may have a flange focal length of 17.526 mm. The flange focal length refers to the distance from the seating shoulder of the adapter to the image plane.

According to one aspect, the camera adapter comprises a plurality of lenses which are arranged in two groups in the direction of the beam path from the object field to the image field.

In this context, a lens group refers to one or more lenses with a common mount. If a group contains multiple lenses, they are generally cemented. However, several lenses in a group may also be decemented.

For example, a lens group may comprise a cemented member with two or more lenses cemented to one another or may consist of such a cemented member.

According to one aspect, the first group G1 of the lenses Lᵢ in the adapter may have a focal length in the range from 50 mm to 200 mm, for example in the range from 100 mm to 150 mm.

The first group G1 of the lenses Lᵢ in the adapter may have a positive refractive power for example. This allows the chief rays of the beams from the object field to be steered in the direction of the optical axis. The diameter of the beam can be reduced as a result. This allows the entire beam to be guided through the image-side connector of the camera adapter without being shadowed.

For example, the first group may comprise a lens which has a diameter that is greater than a clear internal diameter of the image-side connector.

For example, the first lens group may be designed such that it leads to the beam path being focused in such a way that the beam path is guided through the image-side connector in substantially unobstructed fashion, for example in completely unobstructed fashion.

For example, the vignetting of the beam path affects less than 20% of the field of view diameter, for example no more than 10% and for example no more than 5% of the field of view diameter.

According to an aspect, the object-side connector may have a larger clear internal diameter d_{O} than the image-side connector. The ratio of the internal clear diameter d_{O} of the object-side connector to the internal clear diameter de of the image-side connector may for example be at least 1.1, for example at least 1.2.

The first group of the lenses may for example comprise a positive lens, i.e. a lens with positive refractive power. For example, the first group may consist of such a positive lens.

For example, the positive lens may be made of a crown glass. For example, the positive lens may be made of a material with an Abbe number ve of at least ve greater than or equal to 55, for example with ve greater than or equal to 75.

This can allow for particularly good correction of the longitudinal chromatic aberration and/or of the transverse chromatic aberration.

For example, the positive lens may be made of a material with a refractive index of at least 1.5.

For example, the positive lens may have a focal length of no more than 150 mm, for example of no more than 135 mm.

According to an aspect, the second group of the lenses may have a focal length in the range from −350 mm to −50 mm. The second group may for example comprise a negative lens, i.e. a lens with negative refractive power. For example, the focal length of the negative lens may be in the range from −150 mm to −350 mm, for example in the range from −250 mm to −300 mm. The negative lens may be for example in the form of a meniscus lens, for example in the form of a thick meniscus lens. For example, the negative lens may have a thickness of at least 3 mm, for example at least 3.5 mm and for example at least 4 mm.

According to one aspect, the second lens group G2 may have an overall thickness of at least 8 mm, for example at least 10 mm, and for example at least 10.5 mm. The overall thickness is understood to mean the sum of the thicknesses of the lenses L₂ and L₃ of the cemented doublet in the region of the optical axis.

The second group may also be in the form of a combination of a positive lens and a negative lens. For example, the second group may comprise a cemented member, for example a cemented doublet, with a positive lens and a negative lens.

This can allow particularly good correction of the chromatic aberration, for example of the longitudinal chromatic aberration and/or of the transverse chromatic aberration.

For example, the positive lens in the second group may be made of a crown glass. For example, the positive lens in the second group may be made of a material with an Abbe number ve of greater than or equal to 50, for example with ve greater than or equal to 60.

For example, the negative lens in the second group may be made of a flint glass. For example, the negative lens in the second group may be made of a material with an Abbe number 35≤ve≤55, for example 35≤ve≤45.

For example, the Abbe numbers of the two lenses in the second group may differ from each other by at least 15, for example by at least 20, for example by at least 24, and for example by at least 25.

According to an aspect, the refractive indices of the materials of the positive lens and of the negative lens in the cemented doublet of the second group may differ only slightly, especially for the main wavelength, for example for the e-line, λ=546 nm.

For example, monochromatic imaging aberrations at the cemented surface can be avoided as a result.

For the refractive indices of the materials of the two lenses in the cemented member of the second lens group ne₂, ne₁, for example |ne₂−ne₁|<0.1, for example |ne₂−ne₁|<0.05 and for example |ne₂−ne₁|<0.03 applies.

According to an aspect, the second lens group comprises a positive lens and a negative lens, with the respective refractive indices of the materials of these two lenses being at least 1.55, for example at least 1.58.

The refractive indices might for example be no more than 1.7, for example no more than 1.64 and for example no more than 1.62.

The use of materials with large refractive indices allows for improved field curvature correction.

According to an aspect, the second lens group may comprise exactly two lenses. For example, the second lens group may comprise exactly one positive lens and exactly one negative lens. For example the two lenses may be cemented to each other. This leads to an improved mount.

In an alternative to this, the two lenses may also be decemented. However, they may be held in a common mechanical mount.

According to an aspect, the total number of lenses in the camera adapter might be no more than 3. For example, the total number of lenses may be 2 or 3.

It was found that even in the case of such a small number of lenses, a substantially unobstructed transmission of the full étendue on to the camera sensor is possible, even in the case of a large field of view. At the same time, the adapter may be corrected particularly well in relation to chromatic aberrations and/or in relation to monochromatic aberrations, for example field curvature.

For example, in the intermediate image of the camera adapter, the transverse aberrations can be ≤5 μm in the spectral range between 440 nm and 640 nm. For example, they are close to the diffraction limit.

According to an aspect, the second lens group overall may be in the form of a meniscus. For example, all lenses in the second lens group, for example all lenses in the adapter, may be in the form of meniscus lenses.

In that case, the beams are incident on the lens surfaces as steeply as possible. This can lead to particularly small aberrations.

An issue that can be addressed by the disclosure is that of improving a combination of a camera and a camera adapter for a microscope

The disclosure provides a combination of a camera with a camera adapter according to the description above.

The advantages arise from those of the camera adapter.

For example, the camera may comprise a sensor with a diagonal of at least 10 mm, for example a diagonal of 11 mm, or a diagonal of at least 15 mm, for example a diagonal of 16 mm.

A further issue addressed by the disclosure is that of improving a microscope, for example a wide-field microscope and for example a fluorescence microscope.

The disclosure provides a microscope having a camera adapter according to the description above.

The advantages arise from those of the camera adapter.

For example, the camera adapter may be arranged on a stand of the microscope.

To this end, the stand may for example have a camera output.

The camera output can be arranged in the beam path of the microscope, for example downstream of the tube lens.

The camera output may be provided in addition to a beam path to an eyepiece or as an alternative. For example, a beam splitter or an adjustable element—for example in the form of a mirror—that can be used to optionally guide the beam path to an eyepiece or to the camera output may be provided in the beam path downstream of the tube lens.

For example, the camera adapter is designed such that the first lens is located upstream of the intermediate image, for example upstream of the intermediate image already present, when the camera adapter is arranged on the stand of a microscope. The distance between the first lens of the camera adapter and the intermediate image is for example in the range from 40 mm to 80 mm, for example in the range from 50 mm to 70 mm.

The distance between the last lens of the camera adapter in the beam path of the microscope, for example the vertex of the last lens, and the intermediate image is for example at least 18 mm. For example, it is in the range from 20 mm to 24 mm. The C-mount connector can be assisted particularly well as a result.

According to an aspect, all lenses in the second lens group, for example all lenses in the adapter, may be arranged outside the stand of the microscope.

For example, all lenses of the adapter may be arranged in the beam path downstream of an object-side seating surface of the adapter, for example downstream of the object-side connector of the adapter.

The lenses of the adapter thus do not require any installation space in the interior of the stand. Hence the adapter can be used very flexibly with in general any desired stand, for example with microscopes with a standardized camera output.

The first lens can also project into the stand, i.e. be arranged within the stand.

According to an aspect, the microscope comprises a field of view with a field of view diameter d_{SF} and an image acquisition device, for example in the form of a camera, having a sensor with a sensor diameter d_{Sens}, wherein the diameter d_{SF} of the field of view is greater than the diameter d_{Sens} of the sensor, d_{SF}>d_{Sens}.

In this case, the field of view can be imaged onto the sensor of the image acquisition device via the camera adapter, in such a way that the vignetting of the field of view makes up less than 20%, for example no more than 10% and for example no more than 5% of the field of view diameter.

The field of view diameter d_{SF} is more than 20 mm for example, for example at least 23 mm and for example at least 25 mm.

Further features and details of the disclosure will become apparent from the following description of exemplary embodiments with reference to the figures.

### BRIEF DESCRIPTION OF THE DRAWINGS

In the drawings:

FIGS. 1A to 1C schematically show the beam path of microscopic imaging in the region between the image-side connector of a camera adapter and the image field for different magnifications and different numerical apertures,

FIG. 2 shows a schematic illustration of a microscope beam path in the region between a camera adapter and the image plane according to the present disclosure,

FIG. 3 schematically shows the structure of a microscope having a camera adapter and a camera,

FIG. 4 schematically shows the beam path in a camera adapter according to a first variant and

FIG. 5 schematically shows the beam path in the region of a camera adapter according to a further variant.

### DETAILED DESCRIPTION

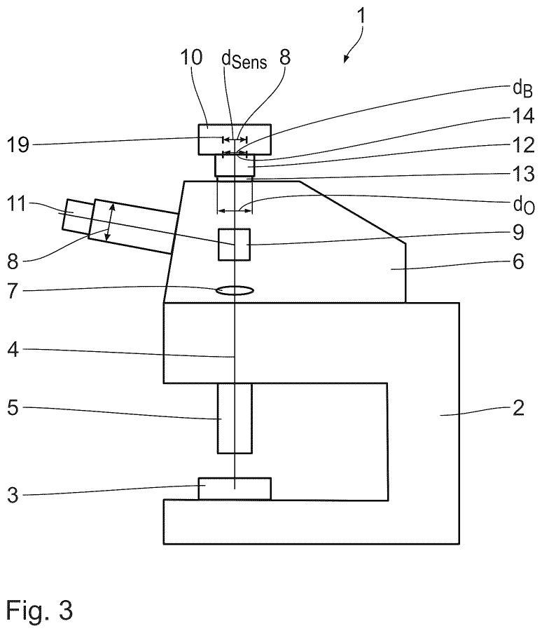

Initially, the general structure of a microscope 1 is described below with reference to FIG. 3. Neither this description nor the schematic illustration in FIG. 3 should be construed as restrictive.

FIG. 3 illustrates an upright microscope 1 by way of example. It may likewise be an inverted microscope.

The microscope 1 comprises a stand 2. For example, the stand 2 serves for the arrangement of the optical constituent parts of the microscope 1.

The stand 2 also serves to arrange a sample 3 in the beam path 4 (indicated schematically) of the microscope 1.

For example, the microscope 1 can be a wide-field microscope. For example, it can be a fluorescence microscope. The light source for the microscope 1 is not depicted in FIG. 3.

The microscope 1 comprises at least one objective lens 5.

The microscope 1 comprises a tube unit 6.

The tube unit 6 comprises a tube lens 7. The tube lens 7 may also be a tube lens unit having a plurality of lenses.

The beam path 4 is convergent downstream of the tube lens 7.

A real intermediate image 8 can be generated via the objective lens 5 and the tube lens 7.

A beam guiding unit 9 may be arranged in the beam path 4 downstream of the tube lens 7. The beam guiding unit 9 may be a beam splitter or a beam-deflecting element, for example in the form of a mirror.

The beam guiding unit 9 allows the beam path 4 to be split into or switched between a beam path leading to a camera 10 and a beam path leading to an eyepiece 11.

The camera 10 is secured to the stand 2 via an adapter 12.

For example, the adapter 12 is arranged in the convergent beam path of the microscope 1.

The adapter 12 can be used for example to image the corrected intermediate image 8 onto a sensor of the camera 10.

The adapter 12 comprises an object-side connector 13 in the connection between adapter 12 and stand 2.

The adapter 12 comprises an image-side connector 14 for connecting the camera 10.

The image-side connector 14 may be what is known as a C-mount for example. For example, this is a standardized interface, for example a standardized threaded interface.

The image-side connector 14 may have a specific flange focal length. The flange focal length of the image-side connector 14 may be 17.526 mm for example.

The image-side connector 14 has a clear internal diameter d_{B}.

The clear internal diameter d_{B} of the image-side connector 14 may for example be less than 24 mm, for example might be no more than 21.5 mm and for example might be no more than 20 mm.

The clear diameter d_{B} of the image-side connector 14 may for example be smaller than a clear diameter d_{O} of the object-side connector 13.

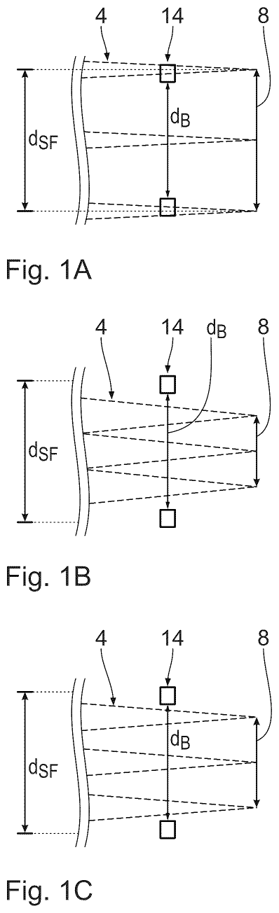

Below, different situations of the beam path 4 in the region between the image-side connector 14 and the intermediate image 8 are explained with reference to FIGS. 1A to 1C.

FIG. 1A depicts the situation for an adapter 12 with a magnification V=1.0 and a numerical aperture in the intermediate image 8 of NA=0.05. As may be gathered from the schematic illustration in FIG. 1A, given a field of view with a diameter of 25 mm, the image-side connector 14 causes an obstruction at the image field edge in this case. The obstruction causes a loss of information.

FIG. 1B depicts, by way of example, the situation for an adapter with a magnification V=0.5 and a numerical aperture in the image field of NA=0.10.

In this case, an obstruction caused by the image-side connector 14 can be avoided. However, the maximum usable sensor diameter is correspondingly smaller here on account of the small magnification V=0.5. Hence, the pixel dimension of the sensor is reduced accordingly for a given resolution. This leads to a reduction in the dynamic range. This is disadvantageous, especially for low-light applications.

For low-light applications, for example in wide-field microscopy, especially in fluorescence microscopy, it is desirable to image the entire étendue of the stand 2, for example of the objective lens 5, onto a camera 10 which has pixels that are as large as possible and hence has a sensor that is as large as possible. FIG. 1C illustrates that with the aid of an adapter 12 with a magnification of V=0.63, a field of view with a diameter of 25 mm can be imaged onto a sensor with a sensor diagonal d_{Sens} of 16 mm. In this case, an obstruction of the image field edge by the internal diameter of the image-side connector 14 can be avoided, even in the case of an image-side numerical aperture of NA=0.08. For example, such an adapter 12 allows the transmission of the entire étendue of a field of view with a diameter of 25 mm without obstruction onto a camera sensor 19 with a diameter d_{Sens}=16 mm.

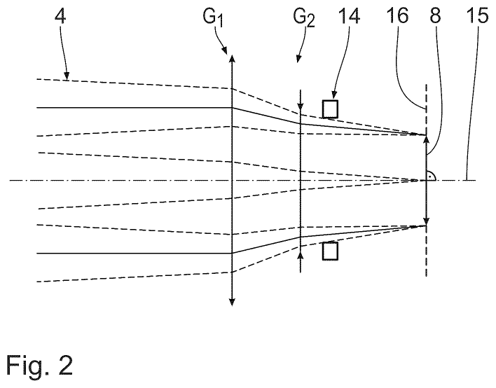

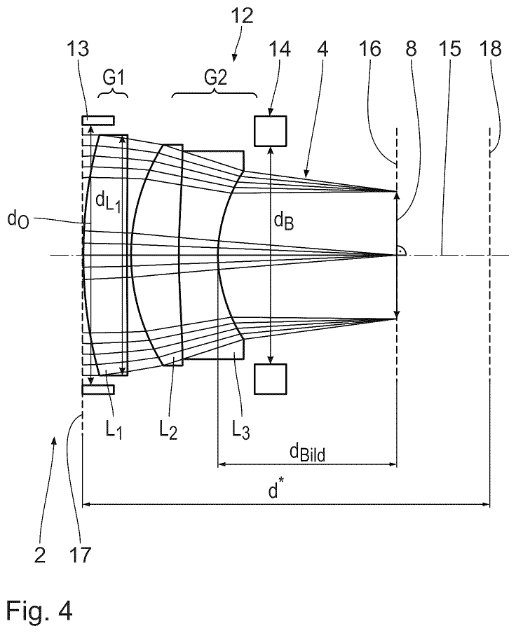

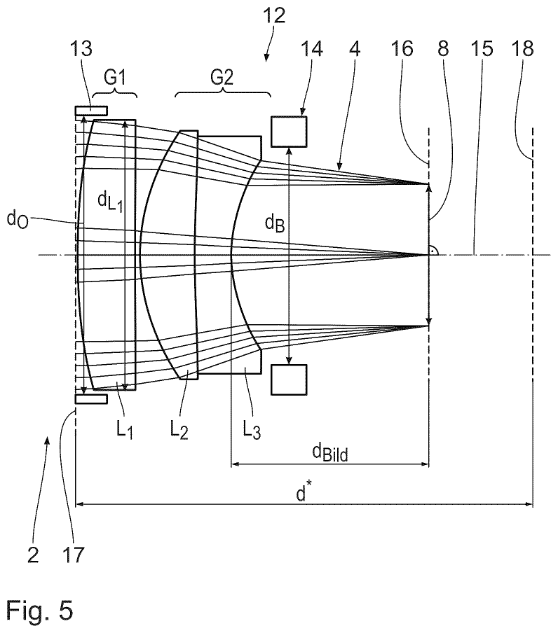

Initially, general properties of the adapter 12 are explained below on the basis of FIG. 2. Thereupon, specific variants of possible embodiments of the adapter 12 are described on the basis of FIGS. 4 and 5.

According to the disclosure, it was recognized that the object-side lens of the adapter 12 is arranged relatively far upstream of the image-side connector 14 in the beam path provided that the adapter consists only of a single lens or a single lens group. As a rule, there is insufficient space for this. According to the disclosure, provision is therefore made for the beam path 4 to be initially focused via a first lens group G1. For example, the lens group G1 has a positive refractive power.

A second lens group G2 with negative refractive power is arranged downstream of the first lens group G1 in the beam path 4. As a result of the second lens group G2, the beams are incident on the image plane 16 less obliquely, i.e. with an angle of incidence relative to a normal 15 that is as small as possible.

FIG. 4 schematically illustrates the beam path 4 in the adapter 12 according to a first variant. The mechanical constituent parts of the microscope 1, for example of the stand 2 and of the adapter 12, have not been depicted realistically in FIG. 4. Merely the pose of the stand 2, for example of an outer side 17 of the stand 2, is indicated. Furthermore, the pose of the object-side connector 13 and the pose of the image-side connector 14 are indicated.

The adapter 12 comprises three lenses L₁, L₂, L₃.

The lenses Lᵢ of the adapter 12 are arranged in two groups G1, G2.

The first group G1 comprises the lens L₁.

The first group G1, for example the first lens L₁, has positive refractive power. The first lens Lᵢ has a focal length of 112 mm.

The second lens group G2 comprises the lenses L₂ and L₃.

The lenses L₂ and L₃ form a cemented doublet.

The second group G2 has a negative refractive power. The focal length of the second lens group G2 is −181.3 mm.

The second lens L₂ has a positive refractive power. The focal length of the second lens L₂ is 49.6 mm.

The third lens L₃ has a negative refractive power. The focal length of the third lens L₃ is −33.0 mm.

The overall thickness of the second lens group G2 is 10.73 mm.

The distance d* from the outer side 17 of the stand 2 to the plane 18 in which the intermediate image would be located were there no use of the adapter 12 is 60 mm.

The distance d_{Bild} between the last lens L₃ in the beam path 4, for example the vertex thereof, and the actual image plane 16 is 22.06 mm.

The distance between the outer side 17 of the stand 2 and the image plane 16 is 38.73 mm.

The lens Lᵢ has a diameter d_{L1}.

The object-side connector 13 has an internal clear diameter d_{O}.

The image-side connector 14 has an internal clear diameter d_{B}.

The following applies: d_{O}>d_{B}.

The following applies: d_{L1}→d_{B}.

The optical design data of the adapter are summarized in Table 1.

TABLE 1

| | | | Refractive | Abbe | Clear |
|---|---|---|---|---|---|
| | Radius | Thickness | index | number | diameter |
| | r in mm | d in mm | ne | ve | in mm |
| | ∞ | 0.07 | | | d_{O} = 30.0 |
| L₁ | 57.381 | 5.37 | 1.53 | 76.6 | 29.8 |
| | 1815.543 | | | | 29.0 |
| | | 0.50 | | | |
| L₂ | 25.418 | 5.90 | 1.59 | 68.0 | 27.3 |
| L₃ | 171.888 | 4.83 | 1.64 | 42.2 | 25.8 |
| | 18.522 | | | | 20.8 |
| | | 4.53 | | | |
| Seating | | 17.53 | | | d_{B} = 20.4 |
| surface | | | | | |
| Image | | | | | 16.0 |

In this context, all specifications in relation to the refractive indices ne and the Abbe numbers ve relate to the e-line, i.e. to light with a wavelength λ=546 nm.

FIG. 5 depicts the beam path 4 in a variant of the adapter 12. The adapter 12 has a similar structure to that according to FIG. 4. The individual constituent parts of the adapter 12 according to FIG. 5 are provided with the same reference signs as in FIG. 4, to the description of which reference is hereby made. Only differences between the adapter 12 according to FIG. 5 and the adapter 12 according to FIG. 4 are described below.

The first lens Lᵢ has a focal length of 130.3 mm.

The focal length of the second lens group G2 is −284.0 mm.

The focal length of the second lens L₂ is 42.5 mm.

The focal length of the third lens L₃ is −31.1 mm.

The overall thickness of the lens group G2 is 10.1 mm.

The distance d_{Bild} between the last lens L₃ in the beam path 4, for example the vertex thereof, and the actual image plane 16 is 22.05 mm.

The distance between the outer side 17 of the stand 2 and the image plane 16 is 39.35 mm.

The optical design data of the adapter according to FIG. 5 are summarized in Table 2.

TABLE 2

| | | | Refractive | Abbe | Clear |
|---|---|---|---|---|---|
| | Radius | Thickness | index | number | diameter |
| | r in mm | d in mm | ne | ve | in mm |
| | ∞ | 0.28 | | | d_{O} = 30.0 |
| L₁ | 64.940 | 6.40 | 1.50 | 81.2 | 29.8 |
| | ∞ | | | | 28.8 |
| | | 0.52 | | | |
| L₂ | 23.376 | 6.10 | 1.59 | 68.0 | 27.3 |
| L₃ | 277.769 | 4.00 | 1.62 | 43.9 | 25.8 |
| | 17.828 | | | | 21.0 |
| | | 4.52 | | | |
| Seating | | 17.53 | | | d_{B} = 20.7 |
| surface | | | | | |
| Image | | | | | 16.0 |

In this context, all specifications in relation to the refractive indices ne and the Abbe numbers ve relate to the e-line, i.e. to light with a wavelength λ=546 nm.

What is claimed is:

1. A camera adapter, comprising:
an object-side connector;
an image-side connector; and
a plurality of lenses arranged in a first group and a second group,
wherein the first group of lenses has a positive refractive power, and the second group of lenses has a negative refractive power.

2. The camera adapter of claim 1, wherein the camera adapter has a paraxial magnification in the range from 0.5 to 0.8.

3. The camera adapter of claim 1, wherein the image-side connector comprises a C-mount connector.

4. The camera adapter of claim 1, wherein the first group of lenses has a focal length in the range from 50 millimeters to 200 millimeters.

5. The camera adapter of claim 1, wherein the first group comprises a positive lens comprising a material with an Abbe number of at least 55.

6. The camera adapter of claim 1, wherein first group comprises a lens having a diameter that is greater than a clear internal diameter of the image-side connector.

7. The camera adapter of claim 1, wherein the second group of lenses has a focal length in the range from −350 millimeters to −50 millimeters.

8. The camera adapter of claim 1, wherein the second group of the lenses comprises a meniscus lens, or the second group of the lenses comprises a combination of a positive lens and a negative lens.

9. The camera adapter of claim 1, wherein the second group of lenses comprises a positive lens which comprises a material with an Abbe number of at least 50, and the second group of lenses comprises a negative lens comprising a material with an Abbe number in the range from 35 to 55.

10. The camera adapter of claim 1, wherein the second group of lenses comprises a positive lens and a negative lens, and a difference between a refractive index of the positive lens and a refractive index of the negative lens is at most 0.1.

11. The camera adapter of claim 1, wherein the second group of the lenses comprises a positive lens and a negative lens, and a difference between a refractive index of the positive lens and a refractive index of the negative lens is at least 1.55.

12. The camera adapter of claim 1, wherein the second group of the lenses comprises a positive lens cemented to a negative lens.

13. The camera adapter of claim 1, wherein the plurality of lenses comprises at most three lens.

14. The camera adapter of claim 1, wherein the camera adapter has the following design data:

| | | | Refractive | Abbe |
|---|---|---|---|---|
| | Radius | Thickness | index | number |
| | r in mm | d in mm | ne | ve |
| L₁ | ∞ | 0.07 | | |
| | 57.381 | 5.37 | 1.53 | 76.6 |
| | 1815.543 | | | |
| | | 0.50 | | |
| L₂ | 25.418 | 5.90 | 1.59 | 68.0 |
| L₃ | 171.888 | 4.83 | 1.64 | 42.2 |
| | 18.522 | | | |
| | | 4.53 | | |
| Seating | | 17.53 | | |
| surface | | | | |

or

| | | | Refractive | Abbe |
|---|---|---|---|---|
| | Radius | Thickness | index | number |
| | r in mm | d in mm | ne | ve |
| | ∞ | 0.28 | | |
| L₁ | 64.940 | 6.40 | 1.50 | 81.2 |
| | ∞ | | | |
| | | 0.52 | | |
| L₂ | 23.376 | 6.10 | 1.59 | 68.0 |
| L₃ | 277.769 | 4.00 | 1.62 | 43.9 |
| | 17.828 | | | |
| | | 4.52 | | |
| Seating | | 17.53 | | |
| surface | | | | |

15. The camera adapter of claim 1, wherein the camera adapter has a paraxial magnification in the range from 0.5 to 0.8, and the image-side connector comprises a C-mount connector.

16. The camera adapter of claim 1, wherein the first group of lenses has a focal length in the range from 50 millimeters to 200 millimeters, the first group comprises a positive lens comprising a material with an Abbe number of at least 55, and the first group comprises a lens having a diameter that is greater than a clear internal diameter of the limage-side connector.

17. The camera adapter of claim 1, wherein:
the second group of lenses has a focal length in the range from −350 millimeters to −50 millimeters; and
the second group of the lenses comprises a meniscus lens, or the second group of the lenses comprises a combination of a positive lens and a negative lens.

18. A camera system, comprising:
a camera; and
a camera adapter according to claim 1.

19. A microscope, comprising a camera adapter according to claim 1.

20. The microscope of claim 19, wherein:
the microscope has a field of view with a diameter;
the microscope comprises an image acquisition device comprising a sensor with a diameter;
the diameter of the field of view is greater than the diameter of the sensor; and
the field of view is imageable onto the sensor via the camera adapter so that a vignetting of the field of view makes up less than 20% of the field of view diameter.
